(19) United States
(12) Patent Application Publication
(10) Pub. No.: US 2015/0370123 A1
(43) Pub. Date: Dec. 24, 2015

(54) DISPLAY SUBSTRATE, METHOD FOR MANUFACTURING THE SAME, AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Jiuxia YANG, Beijing (CN); Feng BAI, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 14/519,504

(22) Filed: Oct. 21, 2014

(30) Foreign Application Priority Data
Jun. 20, 2014 (CN) 201410281381.5

(51) Int. Cl. G02F 1/1335; G02B 5/20

(52) U.S. Cl. CPC G02F 1/133514; G02B 5/201; G02F 1/133516; G02F 1/133512

(57) ABSTRACT

The present invention provides a display substrate, a method of manufacturing the same and a display device, and relates to a field of display technology. The present invention solves a problem that an existing color film layer has a poor heat resistance and a low color saturation. The display substrate of the present invention includes: a base substrate, a color film layer provided on the base substrate, and a first barrier layer provided above the color film layer, wherein a material for forming the color film layer includes a quantum dot, and the first barrier layer is used to isolate the color film layer from air.

### CROSS REFERENCE TO RELATED APPLICATION

This application claims priority to Chinese Patent Application No. 201410281381.5 filed on Jun. 20, 2014, the disclosures of which are incorporated in their entirety by reference herein.

### TECHNICAL FIELD

The present invention relates to a display technical field, and particularly relates to a display substrate, a method for manufacturing the same, and a display device.

### BACKGROUND

A Liquid Crystal Display (LCD) has the advantages of having high image quality, a small volume, a low driving voltage, low power consumption, a small influence on human eyesight, thus it is rapidly developed in the market. An existing LCD includes an array substrate, a color film substrate, and liquid crystal encapsulated between the array substrate and the color film substrate. As shown in FIGS. 1 and 2, the color film substrate includes: a glass substrate 1, a black matrix film layer 2 provided on the glass substrate 1, and a color film layer 3. Generally, the color film layer 3 includes film layers of three different colors comprising red, green and blue, and the film layers of three different colors respectively form a red sub-pixel 31, a green sub-pixel 32 and a blue sub-pixel 33 at a position of sub-pixels on a corresponding substrate, and a black matrix is provided between the sub-pixels in order to prevent light leakage and color mixture at a connecting position. A liquid crystal display panel forms light of different colors through harmonizing the three colors comprising red, green and blue, to implement display of various colors, so that a bright-colored image is presented by the LCD. Therefore, the color film substrate is a critical component of the LCD.

An existing material of the color film mainly includes a pigment/dye, a solvent, a resin, a photoinitiator and the like. The color film layer implements display of different colors mainly through the pigments/dyes of different colors. The existing materials of the color film are all organic materials, thus the heat resistance of the color film layer is poor. In addition, color saturation of the color display implemented by the pigment/dye is low, and a requirement of a true color display is difficult to be satisfied.

### SUMMARY

An embodiment of the present invention provides a display substrate, a method for manufacturing the same, and a display device, to solve a problem that the heat resistance of the existing color film layer is poor and the color saturation formed is low.

In order to achieve the above purpose, one embodiment of the present invention employs technical scheme as follows.

One embodiment of the present invention provides a display substrate, which includes: a base substrate, a color film layer provided on the base substrate, and a first barrier layer provided above the color film layer, wherein a material for forming the color film layer includes a quantum dot, and the first barrier layer is used to isolate the color film layer from air.

An embodiment of the present invention provides a method for manufacturing a display substrate, which includes:

forming a color film layer material including a quantum dot in a vacuum environment;

forming a color film layer on a base substrate in the vacuum environment; and

forming a first barrier layer on the base substrate in the vacuum environment.

One embodiment of the present invention provides a display device, which includes the display substrate provided by the above embodiment of the present invention and a backlight module.

One embodiment of the present invention provides a display device, which includes the display substrate provided by the above embodiment of the present invention.

The embodiments of the present invention provides the display substrate, the method for manufacturing the same and the display device, and the color film layer on the substrate is formed by the material including the quantum dot, the quantum dot is stimulated to generate light with high color purity, thus the color saturation of display is improved, and the heat resistance of quantum dot material is strong, thus the manufacture of other film or layer structure on the substrate can be facilitated.

### BRIEF DESCRIPTION OF THE DRAWINGS

In order to clearly explain the technical scheme in the embodiments of the present invention or the prior art, the appended drawings mentioned in describing the embodiments or the prior art will be simply introduced below. Apparently, the appended drawings in the following description are only embodiments of the present invention, and other drawing may also be obtained by those skilled in the art according to these appended drawings without a creative work.

FIG. 1 is a schematic structural view of an existing color film substrate;

FIG. 2 is a schematic view along a direction A-A′ of FIG. 1;

FIG. 3 is a section view of a display substrate provided by an embodiment of the present invention;

FIG. 4 is a section view of another display substrate provided by an embodiment of the present invention;

FIG. 5 is a section view of another display substrate provided by an embodiment of the present invention;

FIG. 6 is a schematic view showing a method for manufacturing a display substrate provided by an embodiment of the present invention;

FIG. 7 is schematic view showing another method for manufacturing a display substrate provided by an embodiment of the present invention; and

FIG. 8 is schematic view showing another method for manufacturing a display substrate provided by an embodiment of the present invention.

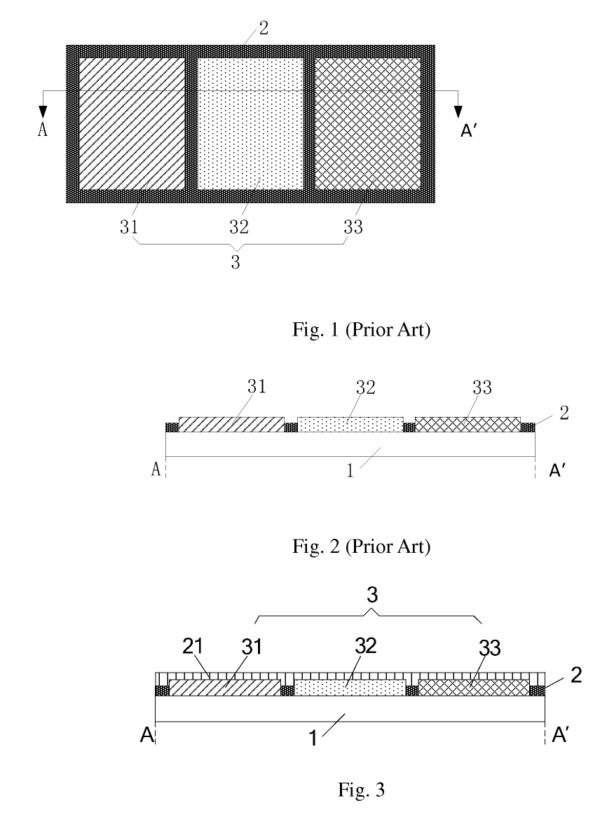

### REFERENCE NUMBERS

1—glass substrate; 2—black matrix film layer; 3—color film layer; 11—pixel electrode layer; 12—commor electrode layer; 21—first barrier layer; 22—second barrier layer; 31—red sub-pixel; 32—green sub-pixel; 33—blue sub-pixel.

### DETAILED DESCRIPTION

The technical scheme in the embodiments of the present invention will be clearly and fully described in detail below, in combination with the appended drawings in the embodiments of the present invention. Apparently, the embodiments described are only a part of the embodiments of the present invention and are not all the embodiments. All other embodiments that can be obtained by a person skilled in the art based on the embodiments in the present invention without a creative work, shall fall within the protection scope of the present invention.

One embodiment of the present invention provides a display substrate, as shown in FIG. 3, which includes a base substrate (which may be a glass substrate 1), a color film layer 3 provided on the base substrate (namely, the glass substrate 1), and a first barrier layer 21 covering the color film layer 3, wherein a material for forming the color film layer 3 includes a quantum dot, and the first barrier layer 21 is used to isolate the color film layer from air.

It should be explained that the quantum dot is also referred to as a nanocrystal, which is a kind of nanoparticle composed of a group II-VI element or a group III-V element. A particle size of the quantum dot is generally between 1 nm and 10 nm, as an electron and a hole are confined by the quantum, a continuous energy band structure becomes a discrete energy level structure having a molecular property, the quantum dot may emit fluorescence after stimulated. In one embodiment of the present invention, the quantum dot is used for a color film material, and then when stimulated by a backlight source, the quantum dot emits light. According to one embodiment of the present invention, light of different colors may be emitted by the quantum dot depending on different particle sizes and different materials of the quantum dot. In addition, a spectrum of the light emitted by the quantum dot is relatively narrow, the light of high color purity can be obtained. The first barrier layer is used to isolate the color film layer from the air, so as to prevent moisture, oxygen and like from contacting with the color film, which influences light emitting performance of the color film.

In the embodiments of the present invention, “above” and “below” is defined by a sequence when manufacturing the array substrate, for example, an above pattern refers to a pattern formed relatively later, and a pattern below refers to the pattern formed previously.

In one embodiment of the present invention, the color film layer 3 may include a red film layer, a green film layer and a blue film layer, that is, as shown in FIG. 3, the color film layer 3 includes a red sub-pixel 31 formed by the red film layer, a green sub-pixel 32 formed by the green film layer, and a blue sub-pixel 33 formed by the blue film layer. Of course, the color film layer may also include a red film layer, a green film layer, a blue film layer, a yellow film layer and like.

One embodiment of the present invention provides a display substrate, wherein the color film layer on the substrate is formed by a material including the quantum dot, the quantum dot is stimulated to generate light with high color purity, thus the color saturation of display is improved, and the heat resistance of the quantum dot material is strong, thus the manufacture of other film or layer structure on the substrate can be facilitated.

According to one embodiment of the present invention, the material for forming the color film layer further includes an organic solvent, a resin, a coupling agent and an additive. Here, the resin is used to make the formed material of the color film easy to form a film, in order to facilitate the manufacture on the substrate. The coupling agent is used to adjust attachment of the formed material of the color film layer, in order to prevent shed of the color film layer due to a weak adhesion between the color film layer and the base substrate. The additive is used to adjust surface tension of the formed material of the color film layer.

According to one embodiment of the present invention, a content of the quantum dot is not more than 10*10⁻¹⁸ mol/mm².

According to one embodiment of the present invention, the content of the organic solvent is 70%-90%. Here, the organic solvent includes methyl ethyl ketone, methyl isobutyl ketone, monomethyl ether gylcol ester, γ-butyrolactone, propionic acid-3-diethyl ether ethyl ester, butyl carbitol, butyl carbitol acetate, propylene glycol monomethyl ether, propylene glycol monomethyl ether acetate and diethylene glycol methyl ethyl ether. Of course, the content of the organic solvent may also be adjusted depending on the requirements of different color film layers, different materials, etc.

According to one embodiment of the present invention, the resin includes acrylic resin and epoxy resin. According to an application of the formed color film layer, the resin may also be phenolic resin and the like. The embodiments of the present invention are described in detail by taking the case only as an example that the resin is acrylic resin and epoxy resin. According to one embodiment of the present invention, the content of the acrylic resin is 15%-35%. Here, acrylic resin includes methyl acrylate, ethyl acrylate, methyl 2-methacrylate, ethyl 2-methacrylate, polyester acrylate, polyurethane acrylate and epoxy acrylate.

According to one embodiment of the present invention, the content of the epoxy resin is 1%-20%. Here, the epoxy resin includes aliphatic epoxy resin and bisphenol A-type epoxy resin.

According to one embodiment of the present invention, the content of the coupling agent is 1%-20%. Here, the coupling agent includes silane, vinyl silane, amino silane, epoxy silane, thiol silane and methacryloxy silane.

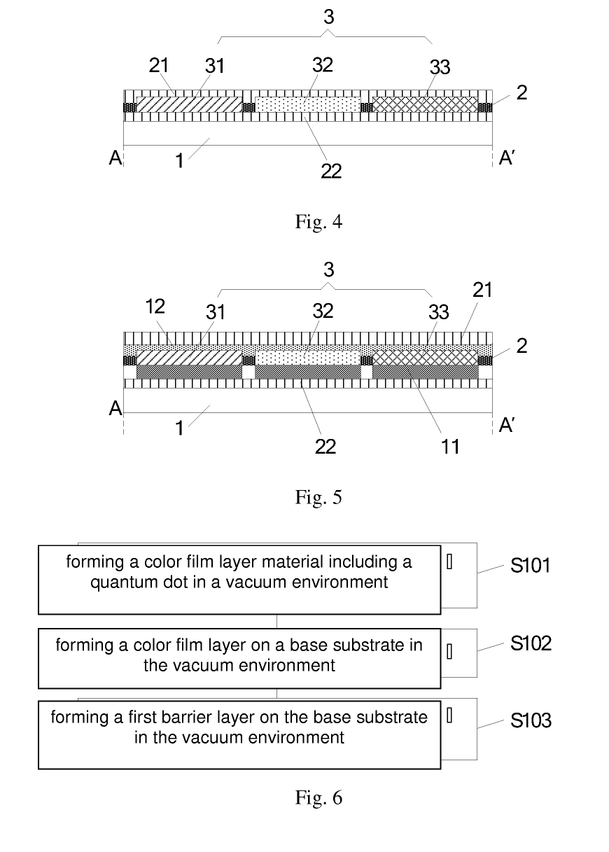

According to one embodiment of the present invention, as shown in FIG. 4, a second barrier layer 22 is further provided between the base substrate (namely, the glass substrate 1) and the color film layer 3. The color film layer 3 is formed above the second barrier layer 22. Namely, the first barrier layer 21 and the second barrier layer 22 are respectively provided above and below the color film layer 3 and adjacent to the color film layer 3, in order to further prevent the color film layer from contacting with water vapor, and to ensure the performance of the color film layer.

According to one embodiment of the present invention, each of the first barrier layer and the second barrier layer includes at least one ceramic layer and at least one resin layer, the ceramic layer and the resin layer are provided alternately. According to one embodiment of the present invention, each of the first barrier layer and the second barrier layer may only include one ceramic layer and one resin layer; each of the first barrier layer and the second barrier layer may also include a plurality of ceramic layers and a plurality of resin layers, and the ceramic layers and the resin layers are provided alternately, namely one ceramic layer is formed, and then one resin layer, and then one ceramic layer, and then one resin layer, thereby a plurality of layers are formed. Of course, the barrier layer may also be a layer structure formed by other material, and the embodiments of the prevent invention are described in detail by taking the above description only as an example.

According to one embodiment of the present invention, the color film layer includes film layers of three different colors comprising red, green and blue, and materials for forming film layers of different colors are the same or different. Generally, a size of the red quantum dot is 8-10 nm, and correspondingly a wavelength of a red light emitted by the red quantum dot is 610-620 nm; the size of the green quantum dot is 5-7 nm, and correspondingly the wavelength of a green light emitted by the green quantum dot is 540-550 nm; the size of the blue quantum dot is 3-5 nm, and correspondingly the wavelength of a blue light emitted by the blue quantum dot is 475-485 nm. The wavelength range of the light emitted by the quantum dot is relatively narrow, thus light with high color purity can be obtained. It should be explained that, in order to obtain the quantum dots that emits light of different colors, different quantum dot materials may be used, or, the same materials of different sizes may also be used.

According to one embodiment of the present invention, the display substrate having the color film layer provided by the present invention may be a color film substrate, or may be an array substrate. It should be explained that, the existing LCD includes the array substrate and the color film substrate, and generally the color film layer is provided on the color film substrate, to realize color display. Of course, the color film layer may also be provided on the array substrate. The color film layer is provided on the array substrate or the color film substrate, and when the quantum dot is stimulated by a backlight source of a display device to emit light, the quantum dot can emit light of different colors depending on the particle size of the quantum dot and different materials of the quantum dot. Further, the spectrum of the light emitted by the quantum dot is relatively narrow, thus the light of high color purity may be obtained.

According to one embodiment of the present invention, as shown in FIG. 5, a pixel electrode layer 11 and a common electrode layer 12 may also be provided on the substrate. According to one embodiment of the present invention, the pixel electrode layer 11 includes a plurality of pixel electrodes (namely, corresponding to each of the sub-pixels); the color film layer 3 is provided between the pixel electrode layer 11 and the common electrode layer 12, and is electrically connected with the pixel electrode layer 11 and the common electrode layer 12.

The color film layer is provided between the pixel electrode layer and the common electrode layer. The pixel electrode may be provided below the color film layer, and the common electrode may be provided above the color film layer. Or, the pixel electrode may be provided above the color film layer, and the common electrode may be provided below the color film layer. All the embodiments and the appended drawings of the present invention are described in detail by taking the case only as an example that the pixel electrode is provided below the color film layer and the common electrode is provided above the color film layer. According to one embodiment of the present invention, a thin film transistor, a grid line, a data line and the like corresponding one by one to the pixel electrode may be formed on the array substrate, in order to add an electrical signal to different pixel electrodes. According to one embodiment of the present invention, adding the electrical signal to different pixel electrodes may be performed with reference to the existing technology of driving the pixel electrode of a display panel, which will not be repeated here.

The color film layer is provided between the pixel electrode layer and the common electrode layer and is electrically connected with the pixel electrode layer and the common electrode layer. Here, the pixel electrode layer and the common electrode layer may be respectively provided at two sides of the color film layer and contacted and electrically connected with the color film layer; or, other film or layer structure may be provided between the color film layer and the common electrode layer, and between the color film layer and the pixel electrode layer, the color film layer is electrically connected with the pixel electrode layer and electrically connected with the common electrode layer through a through hole.

When a voltage is simultaneously applied to the pixel electrode and the common electrode, the color film layer corresponding to the pixel electrode is stimulated to emit light, that is, the display device including the display substrate can emit light so as to implement display without the backlight source.

According to one embodiment of the present invention, as shown in FIG. 5, the pixel electrode layer 11 is provided below the color film layer 3, the common electrode layer 12 is provided above the color film layer 3. Because the pixel electrode layer 11 includes a plurality of pixel electrodes, the pixel electrodes may be formed by patterning. The pixel electrode layer 11 is provided below the color film layer 3, so that the pixel electrode can be first formed by patterning to facilitate manufacture of the pixel electrode, and the common electrode is a planar electrode, which may be formed through spin coating and like methods.

Further, as shown in FIG. 5, the first barrier layer 21 is provided above the common electrode layer 12. In this way, the common electrode layer 12 and the color film layer 3 are directly contacted and electrically connected.

According to one embodiment of the present invention, as shown in FIG. 5, the second barrier layer 22 is provided below the pixel electrode layer 11. In this way, the pixel electrode layer 11 and the color film layer 3 are directly contacted and electrically connected.

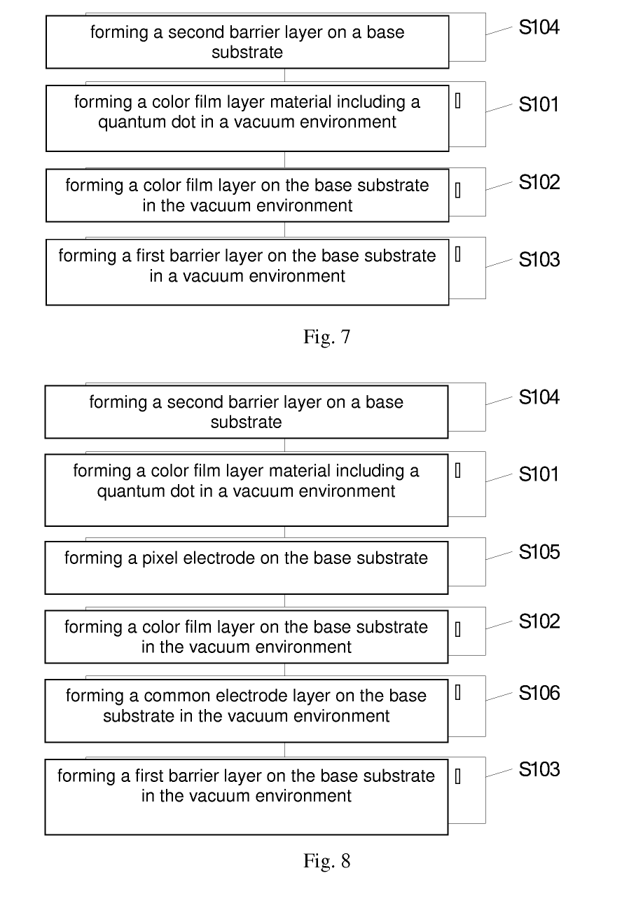

One embodiment of the present invention provides a method for manufacturing a display substrate, as shown in FIG. 6, which includes:

Step 101, forming a color film layer material including a quantum dot in a vacuum environment.

Here, forming the color film layer material including the quantum dot includes: mixing the quantum dot, an organic solvent, a resin, a coupling agent and an additive. According to one embodiment of the present invention, the content of the quantum dot is not more than 10*10-18 mol/mm².

The content of the organic solvent is 70%-90%. According to one embodiment of the present invention, the organic solvent includes methyl ethyl ketone, methyl isobutyl ketone, monomethyl ether gylcol ester, γ-butyrolactone, propionic acid-3-diethyl ether ethyl ester, butyl carbitol, butyl carbitol acetate, propylene glycol monomethyl ether, propylene glycol monomethyl ether acetate and diethylene glycol methyl ethyl ether. Of course, the content of the organic solvent may be adjusted depending on requirements of different film layers, different materials, etc.

The resin includes acrylic resin and epoxy resin. According to an application of the formed color film layer, the resin may also be phenolic resin and the like. The embodiments of the present invention are described in detail by taking the case only as an example that the resin is acrylic resin and epoxy resin. According to one embodiment of the present invention, the content of the acrylic resin is 15%-35%. According to one embodiment of the present invention, the acrylic resin includes methyl acrylate, ethyl acrylate, methyl 2-methacrylate, ethyl 2-methacrylate, polyester acrylate, polyurethane acrylate and epoxy acrylate.

The content of the epoxy resin may be 1%-20%. According to one embodiment of the present invention, the epoxy resin includes aliphatic epoxy resin and bisphenol A-type epoxy resin.

The content of the coupling agent may be 1%-20%. According to one embodiment of the present invention, the coupling agent includes silane, vinyl silane, amino silane, epoxy silane, thiol silane and methacryloxy silane.

Step 102, forming a color film layer on a base substrate in the vacuum environment.

According to one embodiment of the present invention, the color film layer materials of three different colors comprising red, green and blue may be ink-jet printed and solidified one time using different ink-jet printing heads, to form the color film layer; or, different colors of color film layer materials may be ink-jet printed and solidified three times, to form the color film layer. Of course, forming the color film layer by using the color film layer material can also be implemented by a transfer printing process and a laser induced thermal imaging process.

Step 103, forming a first barrier layer on the base substrate in a vacuum environment.

According to one embodiment of the present invention, the first barrier layer covering the color film layer may be formed on the base substrate, the first barrier layer may be formed by directly attaching, onto the color film layer, a thin film of the material for blocking water and air, or by coating and solidifying the material for blocking water and air onto a surface of the color film layer, to form the first barrier layer.

Here, coating the material for blocking water and air onto the surface of the color film layer may includes: forming at least one ceramic layer and at least one resin layer on the base substrate, and the ceramic layer and the resin layer are provided alternately. Namely, forming one ceramic layer on the base substrate, and then forming one resin layer, and then forming one ceramic layer, and then forming one resin layer on the ceramic layer, thereby a plurality of ceramic layers and a plurality of resin layers are formed in turn. Or, it is also possible that only one ceramic layer and one resin layer are formed.

In one embodiment of the present invention, because when the color film layer contacts with the air, it tends to react with moisture, oxygen and the like in the air, and display quality of the color film layer will become worse, therefore, the color film layer and the barrier layer are formed in the vacuum environment.

According to one embodiment of the present invention, another manufacture method is provided by the present invention, as shown in FIG. 7, before forming the color film layer on the base substrate (namely, the above Step 102), the method further includes:

Step 104, forming a second barrier layer on the base substrate.

According to one embodiment of the present invention, forming the color film layer on the base substrate (namely the above Step 102) includes: forming the color film layer on the second barrier layer in the vacuum environment.

It should be explained that, the above Step 104 is before Step 102, which means Step 104 may be between Step 101 and Step 102, or may be before Step 101. The embodiments and the appended drawings of the present invention are described in detail by taking the case only as an example that Step 104 is before Step 101.

According to one embodiment of the present invention, before and after forming the color film layer, respectively, the method further includes: forming the pixel electrode layer and the common electrode layer on the base substrate respectively. According to one embodiment of the present invention, the pixel electrode layer includes a plurality of pixel electrodes.

Additionally, before and after forming the color film layer, respectively, the method further includes: forming the pixel electrode layer and the common electrode layer on the base substrate respectively, which may be carried out by: before and after forming the color film layer in the method illustrated in FIG. 6, respectively, the method further includes forming the pixel electrode layer and the common electrode layer on the base substrate, respectively; or, before and after forming the color film layer in the method shown in FIG. 7, respectively, the method further includes forming the pixel electrode layer and the common electrode layer on the base substrate, respectively.

Before and after forming the color film layer, respectively, the method further includes forming the pixel electrode layer and the common electrode layer on the base substrate, respectively, that is, before and after Step 102, the method further includes forming the pixel electrode layer and the common electrode layer on the base substrate, respectively. Here, before Step 102 may be between Step 101 and Step 102, or may be before Step 101. After Step 102 may be after Step 102, or may be between Step 102 and Step 103, or may be after Step 103. If this step is between Step 102 and Step 103, then it should be carried out in the vacuum environment. Then Step 103 may be carried out in the vacuum environment, or probably in a normal process environment.

According to one embodiment of the present invention, as shown in FIG. 8, before forming the color film layer on the base substrate (namely the above Step 102), the method further includes:

Step 105, forming the pixel electrode on the base substrate.

After forming the color film layer on the base substrate (namely the above Step 102), the method further includes:

Step 106, forming the common electrode layer on the base substrate in the vacuum environment.

Further, according to one embodiment of the present invention, as shown in FIG. 8, forming the common electrode layer on the base substrate in the vacuum environment (namely Step 106) is carried out after forming the color film layer on the base substrate (namely Step 102) and before forming the first barrier layer on the base substrate (namely Step 103).

Further, according to one embodiment of the present invention, as shown in FIG. 8, before forming the pixel electrode layer on the base substrate (namely Step 105), the method further includes:

Step 104, forming the second barrier layer on the base substrate.

Of course, the specific steps of the manufacturing method are not limited to the above steps. For example, Step 104 may also be carried out between Step 101 and Step 105. The embodiments of the present invention are described in detail by taking the above description only as an example.

One embodiment of the present invention provides a display device, which includes: the display substrate provided by the embodiment of the present invention and a backlight module. Namely, the color film layer may be formed on the color film substrate, or may be formed on the array substrate. The display device may be a display device such as the LCD and the like, and any product or component having a display function which includes the display equipment, such as a television, a digital camera, a mobile phone, a panel computer and the like. Display of different colors is implemented by the color film layer of the display substrate under stimulation of the backlight module.

One embodiment of the present invention provides a display device, which includes the display substrate provided by the embodiment of the present invention, wherein the display substrate includes the pixel electrode and the common electrode, and an electrical signal may be loaded by using the pixel electrode and the common electrode to stimulate the quantum dot of the color film layer to emit light, thus display is implemented, without using the backlight source. The display device may be the display equipment such as an Organic Liquid Crystal Diode (OLED) and the like, and any product or component having the display function which includes the display equipment, such as the television, the digital camera, the mobile phone, the panel computer and the like.

All these described above are only specific embodiment of the present invention, but the protection scope of the present invention is not limited to this. An alternation or a substitution derived easily within the technical scope disclosed in the present invention by any person skilled in the art should be covered within the protection scope of the present invention. Therefore, the protection scope of the present invention should be determined by the protection scope of the claims.

What is claimed is:

1. A display substrate, comprising: a base substrate, a color film layer provided on the base substrate, and a first barrier layer provided above the color film layer, wherein a material for forming the color film layer comprises a quantum dot, and the first barrier layer is used to isolate the color film layer from air.

2. The substrate according to claim 1, wherein the material for forming the color film layer further comprises an organic solvent, a resin, a coupling agent and an additive.

3. The substrate according to claim 1, wherein a content of the quantum dot is not more than 10*10⁻¹⁸ mol/mm².

4. The substrate according to claim 2, wherein a content of the organic solvent is 70%-90%.

5. The substrate according to claim 2, wherein the organic solvent comprises methyl ethyl ketone, methyl isobutyl ketone, monomethyl ether gylcol ester, γ-butyrolactone, propionic acid-3-diethyl ether ethyl ester, butyl carbitol, butyl carbitol acetate, propylene glycol monomethyl ether, propylene glycol monomethyl ether acetate and diethylene glycol methyl ethyl ether.

6. The substrate according to claim 2, wherein the resin comprises acrylic resin and epoxy resin.

7. The substrate according to claim 6, wherein a content of the acrylic resin is 15%-35%.

8. The substrate according to claim 6, wherein the acrylic resin comprises methyl acrylate, ethyl acrylate, methyl 2-methacrylate, ethyl 2-methacrylate, polyester acrylate, polyurethane acrylate and epoxy acrylate.

9. The substrate according to claim 6, wherein a content of the epoxy resin is 1%-20%.

10. The substrate according to claim 6, wherein the epoxy resin comprises aliphatic epoxy resin and bisphenol A-type epoxy resin.

11. The substrate according to claim 2, wherein a content of the coupling agent is 1%-20%.

12. The substrate according to claim 2, wherein the coupling agent comprises silane, vinyl silane, amino silane, epoxy silane, thiol silane, and methacryloxy silane.

13. The substrate according to claim 1, wherein a second barrier layer is further provided between the base substrate and the color film layer, the color film layer is formed above the second barrier layer.

14. The substrate according to claim 1, wherein the first barrier layer comprises at least one ceramic layer and at least one resin layer, the ceramic layer and the resin layer are provided alternately.

15. The substrate according to claim 13, wherein the second barrier layer comprises at least one ceramic layer and at least one resin layer, the ceramic layer and the resin layer are provided alternately.

16. The substrate according to claim 1, wherein the color film layer comprises film layers of three different colors comprising red, green and blue, and materials for forming the film layers of different colors are the same or different.

17. The substrate according to claim 1, wherein the substrate is a color film substrate or an array substrate.

18. The substrate according to claim 1, wherein a pixel electrode layer and a common electrode layer are further provided on the substrate, and the pixel electrode layer comprises a plurality of pixel electrodes; the color film layer is provided between the pixel electrode layer and the common electrode layer, and is electrically connected with the pixel electrode layer and the common electrode layer.

19. The substrate according to claim 18, wherein the pixel electrode layer is provided below the color film layer, and the common electrode layer is provided above the color film layer.

20. The substrate according to claim 19, wherein the first barrier layer is provided above the common electrode layer.

21. The substrate according to claim 19, wherein a second barrier layer is further provided between the base substrate and the color film layer, the second barrier layer is provided above the color film layer and below the pixel electrode layer.

22. A method for manufacturing a display substrate, comprising:
forming a color film layer material comprising a quantum dot in a vacuum environment;
forming a color film layer on a base substrate in the vacuum environment; and
forming a first barrier layer on the base substrate in the vacuum environment.

23. The method according to claim 22, before forming the color film layer on the base substrate, the method further comprises:
forming a second barrier layer on the base substrate;
wherein forming the color film layer on the base substrate comprises: forming the color film layer on the second barrier layer.

24. The method according to claim 22, before and after forming the color film layer, respectively, the method further comprises: respectively forming a pixel electrode layer and a common electrode layer on the base substrate, wherein the pixel electrode layer comprises a plurality of pixel electrodes.

25. The method according to claim 24, before forming the color film layer on the base substrate, the method further comprises:
forming the pixel electrode layer on the base substrate; and
after forming the color film layer on the base substrate, the method further comprising:
forming the common electrode layer on the base substrate in the vacuum environment.

26. The method according to claim 25, wherein forming the common electrode layer on the base substrate in the vacuum environment is carried out after forming the color film layer on the base substrate and before forming the first barrier layer on the base substrate.

27. The method according to claim 25, before forming the pixel electrode layer on the base substrate, the method further comprises:
forming a second barrier layer on the base substrate.

28. The method according to claim 22, forming the color film layer material comprising the quantum dot comprises: mixing the quantum dot, an organic solvent, a resin, a coupling agent and an additive.

29. The method according to claim 22, forming the first barrier layer on the base substrate comprises: forming at least one ceramic layer and at least one resin layer on the base substrate, wherein the ceramic layer and the resin layer are provided alternately.

30. The method according to claim 23, forming the second barrier layer on the base substrate comprises: forming at least one ceramic layer and at least one resin layer on the base substrate, wherein the ceramic layer and the resin layer are provided alternately.

31. A display device, comprising the display substrate according to claim 1 and a backlight module.

32. A display device, comprising the display substrate according to claim 18.
